(19) United States
(12) Patent Application Publication
(10) Pub. No.: US 2015/0026798 A1
(43) Pub. Date: Jan. 22, 2015

(54) ELECTRONIC DEVICE AND METHOD FOR IDENTIFYING A REMOTE DEVICE

(71) Applicants: HONG FU JIN PRECISION INDUSTRY (WUHAN) CO., LTD., Wuhan (CN); HON HAI PRECISION INDUSTRY CO., LTD., New Taipei (TW)

(72) Inventors: TONG-QI HUANG, Wuhan (CN); JIAN-HUNG HUNG, New Taipei (TW)

(21) Appl. No.: 14/336,109

(22) Filed: Jul. 21, 2014

(30) Foreign Application Priority Data
Jul. 22, 2013 (CN) 2013103071339

(51) Int. Cl. G06F 21/32

(52) U.S. Cl. CPC G06F 21/32
USPC 726/19

(57) ABSTRACT

An identity is identified by an electronic device. The electronic device receives a connection request from a remote device and controls a remote device to capture an image using the remote device. The electronic device accepts the connection request and authorizes the remote device to access the electronic device upon the condition that the captured image matches a predetermined image stored in the electronic device.

### CROSS-REFERENCE TO RELATED APPLICATIONS

This application claims priority to Chinese Patent Application No. 201310307133.9 filed on Jul. 22, 2013 in the State Intellectual Property Office of the People's Republic of China, the contents of which are incorporated by reference herein.

### FIELD

Embodiments of the present disclosure relate to information security technology, and particularly to an electronic device and a method for identifying a remote device.

### BACKGROUND

For ensuring information security, a username and a password are required for accessing a network device (e.g., a router). However, the username and the password are generally not enough to ensure the information security of the network device.

### BRIEF DESCRIPTION OF THE DRAWINGS

Many aspects of the disclosure can be better understood with reference to the following drawings. The components in the drawings are not necessarily drawn to scale, the emphasis instead being placed upon clearly illustrating the principles of the disclosure. Moreover, in the drawings, like reference numerals designate corresponding parts throughout the several views.

FIG. 1 illustrates a diagrammatic view of an example embodiment of an electronic device.

FIG. 2 is a flowchart of an example embodiment of a method for identifying a remote device.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein.

Several definitions that apply throughout this disclosure will now be presented. The term “module” refers to logic embodied in computing or firmware, or to a collection of software instructions, written in a programming language, such as, Java, C, or assembly. One or more software instructions in the modules may be embedded in firmware, such as in an erasable programmable read only memory (EPROM). The modules described herein may be implemented as either software and/or computing modules and may be stored in any type of non-transitory computer-readable medium or other storage device. Some non-limiting examples of non-transitory computer-readable media include CDs, DVDs, BLU-RAY, flash memory, and hard disk drives. The term “comprising” means “including, but not necessarily limited to”; it specifically indicates open-ended inclusion or membership in a so-described combination, group, series and the like.

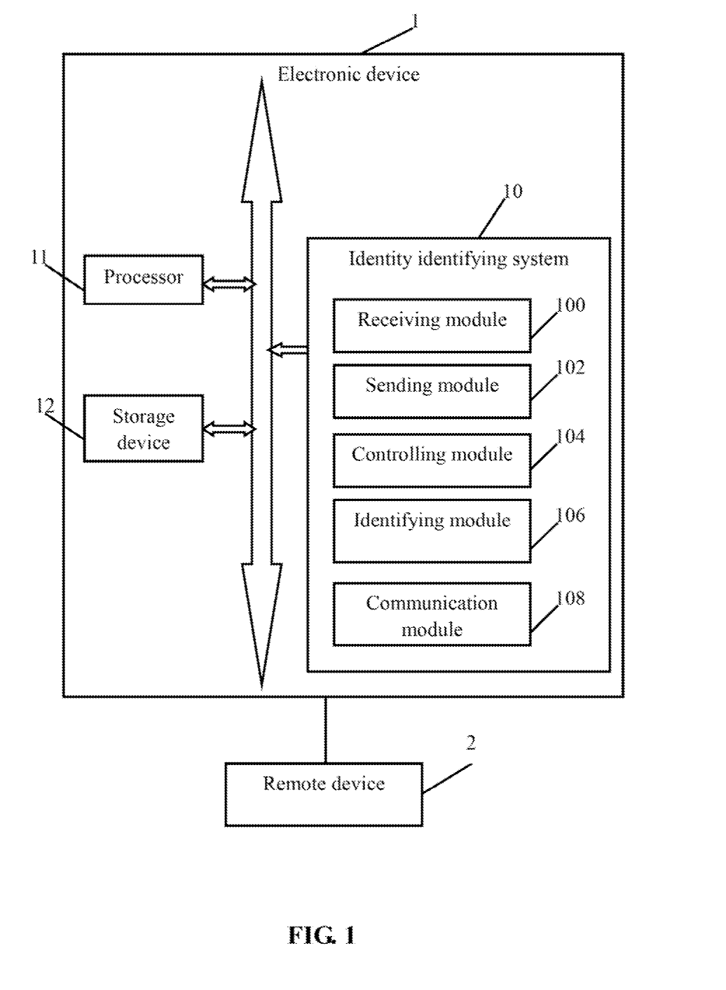

FIG. 1 illustrates a diagrammatic view of an example embodiment of an electronic device. In the embodiment, the electronic device 1 provides functions of network connections, so that a remote device 2 can be connected to the electronic device 1, as shown in FIG. 1. FIG. 1 illustrates only one example of the electronic device 1, and other examples can comprise more or fewer components than those shown in the embodiment, or have a different configuration of the various components. For example, the electronic device 1 provides a wireless network connection, such as a WIFI connection, for the remote device 2 to access to the electronic device 1. The electronic device 1 identifies an identity of the remote device 2 and determines if the remote device 2 is authorized by the electronic device 1.

The electronic device 1 and the remote device 2 can be, but are not limited to, routers, mobile phones, tablet computers, personal digital assistants (PDAs), personal computers or any other electronic devices which provide functions of network connections.

In the example embodiment, the electronic device 1 includes, but is not limited to, an identity identifying system 10, at least one processor 11, and a storage device 12. In one embodiment, the storage device 12 can be an internal storage device, such as a flash memory, a random access memory (RAM) for temporary storage of information, and/or a read-only memory (ROM) for permanent storage of information. The storage device 12 can also be an external storage device, such as an external hard disk, a storage card, or a data storage medium. The at least one processor 11 can be a central processing unit (CPU), a microprocessor, or other data processor chip that performs functions of the electronic device 1. The storage device 12 stores one or more images for identifying an identity of any other electronic device (e.g., the remote device 2). The one or more images can be, but are not limited to, facial pictures of one or more specific users (e.g., a user who is authorized to access the electronic device 1 using the remote device 2).

The identity identifying system 10 comprises, but is not limited to, a receiving module 100, a sending module 102, a controlling module 104, an identifying module 106, and a communication module 108. Modules 100-108 can comprise computerized instructions in the form of one or more computer-readable programs that can be stored in a non-transitory computer-readable medium, for example the storage device 12, and executed by the at least one processor 11 of the electronic device 1. A detailed description of the functions of the modules 100-108 is given below in reference to FIG. 1.

The receiving module 100 is configured to receive a connection request from the remote device 2. The connection request includes an internet protocol (IP) address of the remote device 2, and a serial number of the remote device 2. Furthermore, the connection request can comprise a username and a password inputted through an interface of the remote device 2.

The sending module 102 is configured to send a command to the remote device 2. The command requests the electronic device 2 to capture an image of the user using a camera of the remote device 2. The remote device 2 sends a feedback message to the electronic device 1 after the remote device 2 receives the command. The feedback message indicates if the remote device 2 accepts the command or not. The remote device 2 can discard the command when the remote device 2 rejects the command.

The controlling module 104 is configured to control the camera of the remote device 2 to capture an image of the user when the remote device 2 accepts the command. The image can be a facial picture of the user who uses the remote device 2. In one embodiment, the controlling module 104 activates the camera of the remote device 2 and captures the facial image using the camera. In addition, the controlling module 104 is further configured to verify if the captured image is a facial picture of the user, and extract the characteristic features of the captured image when the captured image is a facial picture of the user. In one embodiment, if the characteristic features of the captured image include a nose, a mouth, two eyes, and a forehead, the captured image is verified as to be a facial picture of the user. If the captured image is not a facial picture of the user, the controlling module 104 is configured to discard the captured image, and repeatedly control the camera of the remote device 2 to capture another image until the captured image is a facial picture of the user.

The receiving module 100 is further configured to receive the captured image from the remote device 2.

The identifying module 106 is configured to compare the captured image with the predetermined image and determine if the captured image matches the predetermined image. In one embodiment, the identifying module 106 is configured to compare the captured image with the predetermined image using a face recognition technology. In detail, characteristic features (e.g., a nose, a mouth, two eyes, and a forehead) are extracted from the captured image and the predetermined image. The characteristic features of the captured image are compared with the characteristic features of the predetermined image, for example, the nose feature of the captured image is compared with the nose feature of the predetermined image.

The communication module 108 is configured to authorize the remote device 2 to access the electronic device 1 upon the condition that the captured image matches the predetermined image. In the example embodiment, the communication module 108 is configured to accept the connection request and establish a communication connection (e.g., a BLUETOOTH™ connection, or WIFI connection) between the electronic device 1 and the remote device 2. That is, the remote device 2 is authorized to directly obtain the data from the electronic device 1 when the communication connection is established. In addition, if the connection request includes the inputted username and the password, the inputted username and inputted password are verified by the electronic device 1. In such a situation, the communication module 108 is configured to authorize the remote device 2 to access the electronic device 1 upon the condition that the captured image matches the predetermined image and the inputted username and the inputted password are included in the storage device 12.

In addition, the communication module 108 is configured to reject the connection request from the remote device 2 upon the condition that the captured image does not match the predetermined image. In addition, if the connection request includes the inputted username and the inputted password, the inputted username and password are verified by the electronic device 1. If the inputted name and the inputted password do not match the predetermined username and the password stored in the storage device 12, the communication module 108 is configured to reject the connection request.

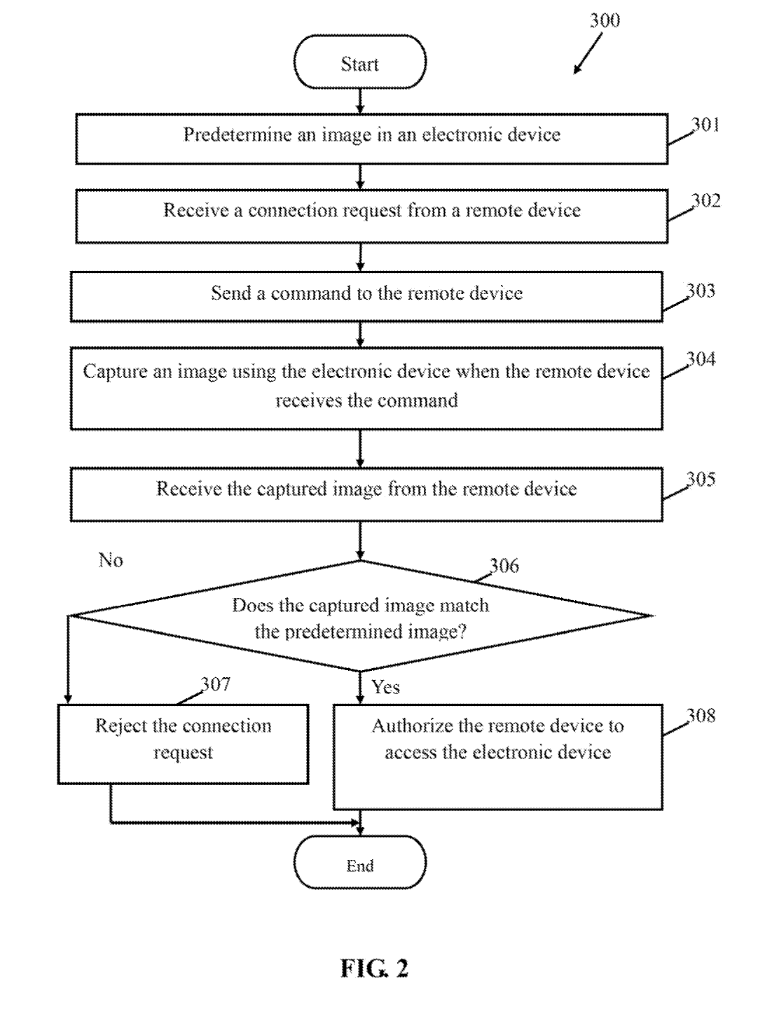

FIG. 2 illustrates a flowchart of an example embodiment of a method for an identity identifying method using an electronic device. In an example embodiment, the method is performed by execution of computer-readable software program codes or instructions by at least one processor of the electronic device, and can identify a remote device connected to the electronic device.

Referring to FIG. 2, a flowchart is presented in accordance with an example embodiment. The method 300 is provided by way of example, as there are a variety of ways to carry out the method. The method 300 described below can be carried out using the configurations illustrated in FIGS. 1 and 2, for example, and various elements of these figures are referenced in explaining method 300. Each block shown in FIG. 2 represents one or more processes, methods, or subroutines, carried out in the method 300. Furthermore, the illustrated order of blocks is illustrative only and the order of the blocks can be changed. Additional blocks can be added or fewer blocks can be utilized without departing from this disclosure. The example method 300 can begin at block 301.

In block 301, an image is predetermined and stored in a storage device of an electronic device. Furthermore, a user name and a password are predetermined and stored in the storage device of the electronic device. The predetermined image is a facial picture of a specific person who is authorized to access the electronic device.

In block 302, a receiving module receives a connection request from the remote device. The connection request includes an IP address of the remote device, a serial number of the remote device, and a username and a password inputted through an interface of the remote device.

In block 303, a sending module sends a command from the electronic device to the remote device. The remote device sends a feedback message (e.g., “YES” or “NO”) to the electronic device after the remote device receives the command. The feedback message indicates if the remote device has accepted the command or not. For example, if the feedback message is “YES”, the remote device has accepted the command. If the feedback message is “NO”, the remote device has rejected the command.

In block 304, a controlling module controls the remote device to capture an image of the user who uses the remote device, when the remote device accepts the command. In one embodiment, the controlling module activates a camera of the remote device and captures the facial image using the camera if the feedback message is “YES”.

In block 305, the receiving module further receives the captured image from the remote device.

In block 306, an identifying module compares the captured image with the predetermined image and determines if the captured image matches the predetermined image. In one embodiment, if the captured image matches the predetermined image, the procedure goes to block 308. Otherwise, if the captured image does not match the predetermined image, the procedure goes to block 307. Furthermore, if the connection request includes the inputted username and the inputted password, the identifying module identifies if the username and the password are correct by comparing them with the predetermined username and the password stored in the storage device. In such a situation, the procedure goes to block 308 upon the condition that the captured image matches the predetermined image and the username and the password are correct. If the captured image does not match the predetermined image, or the inputted username and the inputted password are incorrect, the procedure goes to block 307.

In block 307, a communication module rejects the connection request from the remote device. That is, the connection request is rejected by the electronic device if the captured image does not match the predetermined image.

In block 308, the communication module authorizes the remote device to access the electronic device. In the example embodiment, the communication module accepts the connection request and establishes a communication connection (e.g., a BLUETOOTH™ connection, or WIFI connection) between the electronic device and the remote device. That is, the remote device is authorized to directly obtain the data from the electronic device when the communication connection is established. In addition, if the connection request includes the inputted username and the inputted password, the inputted username and the inputted password are verified by the electronic device. In such a situation, the communication module authorizes the remote device to access the electronic device upon the condition that the captured image matches the predetermined image, and the inputted username and the inputted password matches the predetermined username and the password stored in the storage device.

The embodiments shown and described above are only examples. Even though numerous characteristics and advantages of the present technology have been set forth in the foregoing description, together with details of the structure and function of the present disclosure, the disclosure is illustrative only, and changes may be made in the detail, including in particular the matters of shape, size and arrangement of parts within the principles of the present disclosure, up to and including the full extent established by the broad general meaning of the terms used in the claims.

What is claimed is:

1. An electronic device, comprising:
at least one processor; and
a storage device that stores one or more programs, which when executed by the at least one processor, cause the at least one processor to:
receive a connection request from a remote device;
send a command from the electronic device to the remote device;
send data to the remote device to control a camera of the remote device to capture an image of a user who uses the remote device when the remote device accepts the command;
receive the captured image from the remote device;
determine if the captured image matches the predetermined image by comparing the captured image with a predetermined image stored in the storage device of the electronic device; and
accept the connection request and authorize the remote device to access the electronic device upon the condition that the captured image matches the predetermined image.

2. The electronic device of claim 1, wherein the at least one processor further rejects the connection request from the remote device upon the condition that the captured image does not match the predetermined image.

3. The electronic device of claim 1, wherein storage device further stores a predetermined username and a predetermined password, and the connection request comprises an internet protocol (IP) address of the remote device, and a serial number of the remote device, a username and a password inputted through an interface of the remote device.

4. The electronic device of claim 3, wherein the at least one processor identifies if the inputted username and the inputted password are correct by comparing the inputted username and the inputted password with the predetermined username and the password stored in the storage device.

5. The electronic device of claim 4, wherein the at least one processor further accepts the connection request and authorizes the remote device to access the electronic device upon the condition that the captured image matches the predetermined image and the inputted username and the inputted password are correct.

6. A computer-based method for identifying a remote device using an electronic device, the method for identifying a remote device comprising:
receiving a connection request from the remote device;
sending a command from the electronic device to the remote device;
controlling a camera of the remote device to capture an image of a user who uses the remote device when the remote device accepts the command;
receiving the captured image from the remote device;
determining if the captured image matches the predetermined image by comparing the captured image with a predetermined image stored in the electronic device; and
accepting the connection request and authorizing the remote device to access the electronic device upon the condition that the captured image matches the predetermined image.

7. The method for identifying a remote device of claim 6, the method further comprising:
rejecting the connection request from the remote device upon the condition that the captured image does not match the predetermined image.

8. The method for identifying a remote device of claim 6, wherein the electronic device further stores a predetermined username and a predetermined password, and the connection request comprises an IP address of the remote device, and a serial number of the remote device, a username and a password inputted in an interface of the remote device.

9. The method for identifying a remote device of claim 8, wherein the electronic device identifies if the inputted username and the inputted password are correct by the inputted username and the inputted password comparing with the predetermined username and the password stored in the storage device.

10. The method for identifying a remote device of claim 9, wherein the electronic device further accepts the connection request and authorizes the remote device to access the electronic device upon the condition that the captured image matches the predetermined image and the inputted username and the inputted password are correct.

11. A non-transitory computer-readable medium having stored thereon instructions that, when executed by at least one processor of an electronic device, causing the electronic device to perform a method for identifying a remote device, the method comprising:
receiving a connection request from the remote device;
sending a command from the electronic device to the remote device;
controlling a camera of the remote device to capture an image of a user who uses the remote device when the remote device accepts the command;
receiving the captured image from the remote device;
determining if the captured image matches the predetermined image by comparing the captured image with a predetermined image stored in the electronic device; and
accepting the connection request and authorizing the remote device to access the electronic device upon the condition that the captured image matches the predetermined image.

12. The non-transitory computer-readable medium of claim 11, wherein the method further comprising:
rejecting the connection request from the remote device upon the condition that the captured image does not match the predetermined image.

13. The non-transitory computer-readable medium of claim 12, wherein the electronic device further stores a predetermined username and a predetermined password, and the connection request comprises an IP address of the remote device, and a serial number of the remote device, a username and a password inputted in an interface of the remote device.

14. The non-transitory computer-readable medium of claim 13, wherein the electronic device identifies if the inputted username and the inputted password are correct by the inputted username and the inputted password comparing with the predetermined username and the password stored in the storage device.

15. The non-transitory computer-readable medium of claim 14, wherein the electronic device further accepts the connection request and authorizes the remote device to access the electronic device upon the condition that the captured image matches the predetermined image and the inputted username and the inputted password are correct.
